(19) United States
(12) Patent Application Publication
(10) Pub. No.: US 2009/0171753 A1
(43) Pub. Date: Jul. 2, 2009

(54) ZERO COST LOYALTY & CONSUMER ENGAGEMENT PROGRAM

(76) Inventor: Karthic V.C., Chennai (IN)

Correspondence Address: HAMRE, SCHUMANN, MUELLER & LARSON, P.C., P.O. BOX 2902, MINNEAPOLIS, MN, 55402-0902, US

(21) Appl. No.: 11/966,373

(22) Filed: Dec. 28, 2007

(51) Int. Cl. G06Q 30/00

(52) U.S. Cl. 705/10; 705/14; 705/37

(57) ABSTRACT

A method of using a Zero Cost Loyalty & Consumer Engagement Program comprising the steps of (1) consumer paying a subscription fee to enroll, (2) the company sending a welcome kit detailing the program features, benefits and process, (3) the consumer being credited with the notional currency of the program, (4) the consumer bidding for rewards from an auction catalogue published periodically, (5) the company posting the data entry into the database and validation of the accrued currency claim, and (6) the company issuing a winner report detailing the number of winners & the said rewards, characterized in that the said subscription fees received from the consumers in the said consumer loyalty program generates funds for the implementation of the said program and creates zero cost for the said company.

### FIELD OF THE INVENTION

The present invention belong to the field of business methods and relates to a business model and process that aims at administering a consumer loyalty program by offering notional currency to measure frequency of purchase of the consumer brand itself such as packaging wrappers, airline boarding cards, hotel/restaurant receipts, malls/supermarkets/department stores/convenience store receipts, cab receipts, movie hall/theatre tickets and thereof. In a separate embodiment as part of this invention, the invention can also establish a Zero Cost program to brands, merchants and other business establishments who intend to retain their loyal consumers, with a life cycle of its own.

### BACKGROUND OF THE INVENTION

In the current market scenario, it has become imperative for businesses to offer sops, discounts and rewards to their loyal consumers resulting in an opportunity boom for loyalty marketing. Consumer loyalty has attained a new dimension of late wherein it's not just that the best consumers need to remain loyal to the brand, but they also need to display the following traits, namely:
1. Recency
2. Frequency
3. Higher monetary spend

Today, there are various types of award programs in existence. Some award programs are based on the participant's loyalty or return business, and are called loyalty award programs. Many people are members of one or more loyalty programs. Also known as frequency or loyalty programs, these programs award “points,” “miles” or other credit to the members of the programs in exchange for, or based upon, the purchase of products or the use of services offered by the sponsors of the program.

Loyalty award programs are offered by merchants, credit card companies, and various other types of companies to reward participants for their loyalty or business. All Loyalty and Frequent Flyer programs run across the world for businesses, airlines, restaurants, hotels, malls, supermarkets etc costs the businesses a certain percentage of their profitability, even if the spend is based on incremental value. These programs are critical for businesses to be competitive, by ensuring that their regular/best consumers remain loyal to the brand. Loyalty programs are commonly offered by merchants to track the participant's spending with the respective company and then award the participant loyalty points or coupons based on the amount or number of purchases, for example. In some loyalty programs, the program sponsor will partner with other providers of products or services and points will be awarded based upon the use of the products or services of the partners as well.

A common example of such loyalty programs is the frequent flyer programs offered by airlines. In these frequent flyer programs, members of the program that fly on the sponsor airline or that use the lodging, transportation, or other services of the airline's partners will be awarded points. When a member has accumulated a sufficient minimum number of points, the member can then exchange the points for airline tickets or other benefits on the sponsor's airline or affiliates.

As another example, various credit card loyalty programs are offered by banks today that allow participants to earn cash back and/or other loyalty rewards for signing up for the credit card, for carrying a balance, for completing a transaction using the credit card, and/or for other loyalty-related activities. Such credit card loyalty programs typically allow the participant to redeem the loyalty points for merchandise, travel, gift cards, or they provide cash back at the end of a certain cycle. One shortcoming with loyalty award programs is that participants are not able to earn loyalty awards unless they spend their own money, for example, to purchase something.

United States Patent Application 20070198352 details a transactional system for eliminating the necessity of third party processors, who are typically employed for processing loyalty benefits obtained during various point-of-sale loyalty programs such as rebates, cashbacks, discounts, and etc. The system is to be used in conjunction with credit cards, debit cards, loyalty cards, and so on at a point of sale. The system comprising the steps of forwarding a purchase amount less of a loyalty benefit directly to the account of a merchant at a point of sale, the merchant participating in a corresponding loyalty program, forwarding the loyalty benefit to the account of a benefit recipient at the point of sale, and generating a receipt for the purchase amount at the point of sale, the receipt depicting the break up of the purchase amount.

United States Patent Application 20070174166 speaks about a system and method for creating and managing incentives for buyers of prepaid financial accounts to engage in certain activities with those accounts. Account holders agree to fund a prepaid account with a minimum amount and to forego using the account for an agreed time period, to maintain minimum account balances, to make periodic balance additions, or to satisfy other account requirements in exchange for a reward. The reward may be a money reward, merchandise, discounts, services, enrollment in loyalty programs, preferential treatments, rebates, lottery entries, etc. Whether or not the conditions for a reward are satisfied, the full initial par value of the account is available upon activating the account. Increasing rewards may be issued for increasing time periods where the account requirements are satisfied.

United States Patent Application 20070278288 details an improved system and method for providing a rebate to a third party beneficiary for the purchase of a product from a merchant including the steps of designating a beneficiary for a rebate amount associated with a purchase of goods or services, assigning a rebate amount with one or more restrictions from a merchant based on the purchase of those goods or services by a consumer, and applying one or more rebate amounts to a subsequent purchase by the beneficiary so long as the one or more restrictions are met. Additionally, a computer network-based purchase incentive system for one or more merchants including a memory, the memory adapted to store a program code, a processor in communication with the memory, the program code capable of programming the processor to perform a method for providing a rebate from a merchant for a purchase of a good or service by a consumer, the method comprising the steps of designating a beneficiary of the consumer to receive a rebate amount associated with the purchase, assigning a value and one or more restrictions to the rebate amount; and applying the rebate to a subsequent purchase by the beneficiary so long as the one or more restrictions are met.

In United States Patent Application 20020133400 systems and methods are described which afford greater flexibility for consumers to purchase through either on-line or traditional retail venues and receive a more direct perceived value from reward offerings. The system's network of CPGs enables sponsors and partnered e-commerce retailers to share development, database management, and other administrative costs. Cooperative database mining combined with timely, anticipated and permission-based relevant e-mail communications adds a powerful consumer acquisition component to traditional database and consumer loyalty programs. Member users benefit from the flexibility in the ways in which they can accumulate value in their member user accounts from entering rewards received from CPG Sponsors. Member users also have flexibility in the manner in which they spend value accumulated in their consumer accounts. In the present invention, conducting online transactions with any one of the partnered e-commerce retailers is simplified and streamlined. In particular, an illustrative embodiment of the present invention includes a system facilitating Internet reward services. The system includes a server coupled to the Internet. A website is stored on the server. Software means is operative on the website and the server. The software means receives one or more reward codes for verification against a network of consumer product/service sponsors and credits a proprietary value for valid reward codes to an appropriate member user's account such that a member user can apply the proprietary value to on-line transactions with a number of partnered e-commerce retailers. According to the teachings of the present invention, the software means is further operable for associating a reward activity process with a particular member user account and collecting data associated with an on-line transaction by the member user such that the collected data can be analyzed and shared between the network of consumer product/service sponsors and the number of partnered e-commerce retailers.

United States Patent Application 20030225619 describes a system for exchanging and valuing points or rewards from a plurality of loyalty programs using a “settlement point” in a clearinghouse to settle, convert, credit and debit points between accounts regardless of the type of goods or services. The points are underwritten using assets and guarantees held by a custodian, relying on actuarial estimates of redemption. The points are also used as assets for securities, thereby facilitating the valuing and liquidity of the settlement points, or as assets to secure financial or insurance services.

United States Patent Application 20070118419 claims systems and methods are provided for analyzing a business's profitability. A system for analyzing consumer profitability includes an interface for receiving consumer, revenue and cost data from external business operating systems. Consumer, revenue, and cost data are stored on a database. A data transformation module operates on the consumer data, allocating revenue and costs to individual consumers. A consumer profitability engine calculates the profitability of consumers based on the allocated revenue and cost data. A report module generates reports illustrating the profitability results and other key performance indicators. Optionally, an average consumer lifetime value may be calculated based on the consumer profitability results. A method for analyzing consumer profitability includes identifying sources of revenue, identifying sources of costs, and establishing rules for allocating revenue and costs to individual consumers. The method further includes receiving actual consumer, revenue and cost data and allocating revenue and costs to individual consumers according to the allocation rules. Consumer profitability and KPI values are calculated for individual consumers and reports are generated illustrating the profitability results and various KPIs for individual consumers or groups of consumers sharing a common characteristic.

United States Patent Application 20070043613 details an invention that allows the Consumer to receive a cash credit to their account, as well as other reward alternatives. Receiving cash in the Consumers account with the Merchant leaves no ambiguity as to what the Consumer can purchase, as they can purchase anything at the Merchants site. The present invention relates to electronic commerce (e-commerce) and the purchasing of goods and services. More particularly to Consumer retention and loyalty programs, and still more particularly to creating the ideal Consumer retention and loyalty program by facilitating the exchange between online Advertisers, Merchants, and Consumers.

United States Patent Application 20020046116 claims a system and method for facilitating the distribution and settlement of electronic loyalty programs is described. The system facilitates the distribution of electronic punch card loyalty programs from an offerer, such as a product manufacturer, to an end-user and/or retailer. The user downloads the electronic punch card to a loyalty applet maintained on a microchip-enabled device such as a smart card. This smart card may then be used at various retailers to take advantage of the offerer's loyalty program. Alternatively, the host system may maintain the loyalty punch card without downloading to the user and provide access to a retailer upon the occurrence of a transaction with the user. The retailer is configured to recognize the presence of a loyalty punch card, process loyalty program information and interact with a host loyalty server system to update loyalty program data. A host system computerized clearing house captures loyalty program data and processes this data for settlement (i.e., invoices offerers and pays retailers) so as to extend the loyalty program relationship from the non-point-of-sale offerer to the end-user through a variety of retailer establishments.

Typical loyalty programs can have limited use for many members. For example, under most frequent flyer programs, points are awarded whenever a member travels on the sponsor's airline. These points are awarded based upon the distance traveled by the member. However, the programs require the accumulation of a large number of points before the points can be redeemed for free air travel. For travelers that do not fly regularly, a large amount of time will occur before the member is able to accumulate sufficient points to receive the free travel benefit. Furthermore, under some programs, the awarded points may expire if not redeemed within a specified timeframe. Thus, a member who does not travel frequently may be in jeopardy of losing their points.

Another disadvantage of loyalty programs is that it is not self sustaining and expenses are incurred by the consumer brand to administer a consumer loyalty program.

Another disadvantage of loyalty programs is that the obtained level of points or miles can typically be redeemed only for a free good or service of the company. Thus, the awards for which the member can redeem the points are extremely limited.

Additionally, each loyalty program does not have a fixed number of rewards and hence a fixed amount of spend.

In light of the numerous disadvantages and difficulties associated with loyalty programs, there is a need for a system which is a ready to use, out of the box solution that any industry, brand or business may put to use, without incurring the any cost in running a consumer loyalty program. Furthermore, there is a need that the program is self sustaining and simple to put to use.

The present invention seeks to ensure that consumer brands for whom such programs are administered shall not incur any spend or expense in continuously executing and managing the program as the business model itself is self sustaining and pays for itself, irrespective of the volume of subscribers or the business that the program is run for.

The consumer subscribes to the program at a cost, thus negating expense incurred by the consumer brand to administer a consumer loyalty program. The cost of subscription ensures the expenses of the program, rewards, communication costs and manpower are evened out. This cost is in turn subsidized in full by either goods or services from a third participating brand or brands to ensure that the perceived cost to the consumer is zero.

The program in its current mode may be used to compliment or add value to existing promotions or consumer loyalty programs or frequent flyer programs etc. The proof of purchase is captured at various touch points and the consumer is entitled to bid for rewards.

### SUMMARY OF THE INVENTION

The invention described herein is a ‘Zero Cost’ consumer loyalty program that operates across various kinds of businesses and embodies in itself the no cost model whereby it is ensured that the brand or business that administers the program incurs no expenditure.

Generally speaking, exemplary embodiments of the present invention enable a No Cost loyalty program to the brand where the profiling of consumers captured can be an alternate revenue source for the brand, thus the invention in due course may also generate revenue.

According to an exemplary embodiment of the present invention, the unique bid process in the invention uses notional currency and creates substantial interest & participation amongst the target audience.

A further embodiment of the present invention provides that every auction/bid planned shall have a fixed number of rewards; hence it has a fixed amount of spend. The spend is capped at a pre approved amount.

Yet another embodiment of the present invention provides a no cost promotion that can collect information from their consumers and to position and market their services or products better.

Yet another embodiment of the present invention provides a program structure that is dynamic, flexible and scalable thus ensuring greater level of customization and leverage.

### BRIEF DESCRIPTION OF THE DRAWINGS

FIG. 1 is a stylized overview of the Zero Cost Loyalty & Consumer Engagement Program.

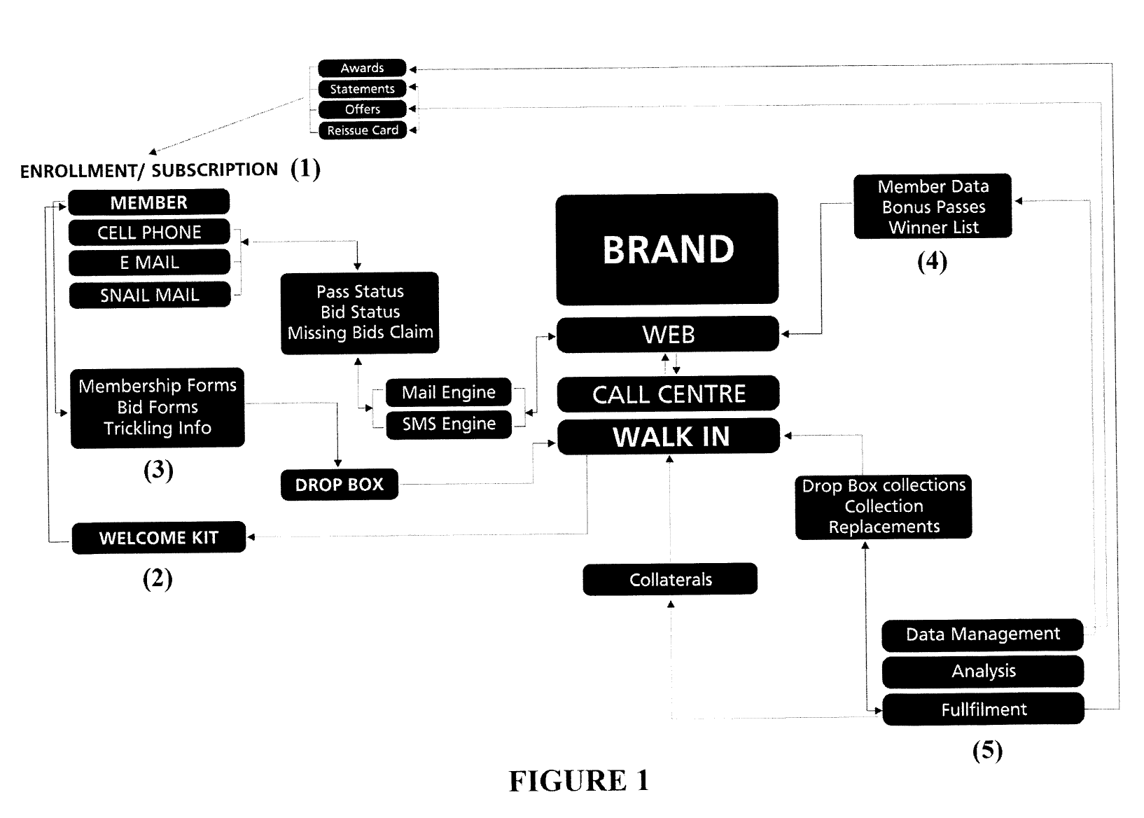

### DETAILED DESCRIPTION OF THE INVENTION

To assist in an understanding of the invention, a preferred embodiment or embodiments will now be described in detail.

A consumer is advised to subscribe/enroll (1) onto the loyalty program at the point of purchase of the product. The consumer has to pay a subscription fee to enroll, which shall be a nominal amount as per the design & structure of the respective program. The sale of the subscription is positioned as an up-sell or cross-sell, whilst transacting business with the brand. Subscriptions can also be in the form of brand/corporate/personal gifting, employee reward/retention activity, consumer reward/gifting, sponsored subscriptions and bundled subscription with other non-competitive products. The touch points of purchase could be any or all of the following:
1. Brand Websites/portals
2. Other Websites/portals
3. Telephone/VOIP Call centers of the brand
4. Telephone/VOIP Call centers of associate brands
5. Retail offices and establishments of the brand
6. Retail offices and establishments of associate brands
7. Post
8. Courier
9. Hand delivery
10. SMS (Short Message Text)
11. Email
12. Proxy purchases
13. Sponsored purchases
14. Bundled purchases
15. Convenience stores
16. Grocery stores
17. Eateries etc.

On subscribing to the program, the consumer receives a welcome kit (2) detailing the program features, benefits and process. The kit shall also carry a unique program subscription number which shall be the primary identification key for all future transactions/communications with the brand.

Post the subscription onto the program, the consumer is credited with the notional currency of the program, such as number of wrappers, stickers, coupons & cartons in the case of FMCG goods, boarding passes, airline tickets etc. in the case of airlines or any other form of purchase receipt that can be captured and recorded. Currency multipliers may be introduced to derive other desired purchase/consumer behaviors.

The notional currency that has been accrued by a consumer, thanks to the purchase of the product, is the entity through which the consumer can bid for rewards from an Auction catalogue that is published periodically. The periodicity of such catalogue is as deemed by the program.

The bidding process (3) is simple and is performed by filling out the bid form of a particular auction and submitting the same. The various modes of bid submission are:
1. EMAIL—consumer can send an email with his/her subscription number, product and bid (accompanied with mobile number for verification) in the subject line. This bid can be auto verified with members account. An auto generated email confirming the acceptance or rejection of members bid can be sent out
2. SMS—Consumer sends a keyword followed with his/her subscription number, product and bid (mobile number is tallied with consumer's registration details for verification). This bid can be auto verified with consumer's account and an SMS/email confirming the acceptance or rejection of consumer's bid can be sent back
3. WEBSITE—Consumer logs in with his/her subscription number and password (provided in the welcome pack) to place bids. A confirmation email/SMS will be sent to the consumer
4. DROPBOX AT STRATEGIC LOCATIONS—Acknowledgement email/SMS will be sent to the consumer
5. POST & COURIER—Acknowledgement email will be sent to the consumer
6. IN-PERSON—where all bidders converge to a common venue or come together on a common platform with the use of technology such as video conferencing or teleconferencing etc.

The bidding could be in the following formats:
1. Highest bid
2. Lowest bid
3. Unique bid
4. Majority bid
5. Minority bid
6. Early bird bids
7. Last bids
8. Pre defined bid slots
9. Roulette and variants of such
10. Lucky draw—manual and variants of such
11. Lucky draw—automated and variants of such
12. Test of skill—such as strap line writing, competing in a game and variants of such
13. American Auction

Incase of an equal number of bids submitted and reasons of ambiguity arising, the following yardstick shall be used to decide the rewarded consumer:
1. The consumer with the highest number purchase account
2. The consumer with the highest amount purchase account
3. The consumer whose submission has been the 1st on record
4. As defined by the administrator/proprietor of the auction Unique bid
5. The consumer with the majority bid
6. The consumer with the minority bid
7. The consumer with the early bird bid
8. The consumer with the last bids
9. The consumer with the a pre-defined bid slots
10. Roulette and variants of such
11. Lucky draw—manual and variants of such
12. Lucky draw—automated and variants of such
13. Test of skill—such as strap line writing, competing in a game and variants of such Incase of non-claim of a winner or expiry of the claim period, the next eligible bidder shall be awarded.

Post the data entry into the database and validation of the accrued currency claim (manual & automated), a winner report (4) (using a proprietary software) shall be generated detailing the number of winners & the rewards. The winners shall be intimidated via phone call, SMS, email, post or any such mode of communication through the effective use of technology, to claim their reward.

The rewards available for bid are dynamic & the consumers bid with the notional currency that they have accrued over a period of time. The rewards format could any or all of the following options:
1. Ascending pyramid of rewards (multiple & dynamic tiers/slabs)
2. Descending pyramid of rewards (multiple & dynamic tiers/slabs)
3. Flat tier/slab of rewards
4. Singular reward (winner take all format)
5. Roulette of rewards
6. The winning bidders may pick the reward of a lucky draw
7. Or any such formats

The rewards could be notional, in kind or services such as:
1. Rewards offered as service of the brand
2. Rewards offered as product/s of the brand
3. Lifestyle rewards
4. Discount coupons
5. Gift vouchers
6. Experiential rewards
7. Automobiles
8. Complementary services or products of associate/sponsored brands

At regular intervals, every bid form, costumer profiling (5) may be sought in small formats, thus negating the time or pain of a consumer in divulging information on themselves. The psychographics and demographics of the consumer are captured thus assisting the brand/associate brands to map consumers better and offer innovative and competitive services & products.

The present invention effectively frames a consumer loyalty program that pays for itself. The subscription/enrollment fees received from the consumers in turn ensures funds for rewards, consumer benefits, marketing & advertising, logistics and infrastructure, manpower etc. This is ensured by the ingenuity of the design of the revenue model wherein the subscription being unlimited, the spend is limited. Every auction/bid planned shall have a fixed number of rewards, hence it has a fixed amount of spend, thereby ensuring that irrespective of the notional currency that is recorded with every purchase/consumer behavior, the spend is capped at a pre approved amount.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features hereinbefore set forth.

1. A method of using a Zero Cost Loyalty & Consumer Engagement Program comprising the steps of (1) consumer paying a subscription fee to enroll, (2) the company sending a welcome kit detailing the program features, benefits and process, (3) the consumer being credited with the notional currency of the program, (4) the consumer bidding for rewards from an auction catalogue published periodically, (5) the company posting the data entry into the database and validation of the accrued currency claim, and (6) the company issuing a winner report detailing the number of winners & the said rewards, wherein the said subscription fees received from the consumers in the said consumer loyalty program generates funds for the implementation of the said program and creates zero cost for the said company.

2. A method of using a Zero Cost Loyalty & Consumer Engagement Program as claimed in claim 1 wherein said consumer subscriptions can be in several forms including but not limited to bundled subscription with other non-competitive products.

3. A method of using a Zero Cost Loyalty & Consumer Engagement Program as claimed in claim 1 wherein the said welcome kit contains a unique program subscription number as the primary identification key for all future transactions in the said consumer loyalty program.

4. A method of using a Zero Cost Loyalty & Consumer Engagement Program as claimed in claim 1 wherein the said notional currency can be in several forms including but not limited to wrappers, stickers, coupons & cartons in the case of FMCG goods, boarding passes, airline tickets or any other form of purchase receipt that can be captured and recorded.

5. A method of using a Zero Cost Loyalty & Consumer Engagement Program as claimed in claim 1 wherein the said rewards available for bid are dynamic & can be bid with the notional currency that consumers have accrued over a period of time.

6. A method of using a Zero Cost Loyalty & Consumer Engagement Program as claimed in claim 1 wherein during the said bidding, consumer profiling can be sought in small formats at regular intervals.

7. A method of using a Zero Cost Loyalty & Consumer Engagement Program as claimed in claim 1 wherein the said profiling of consumers can be an alternate revenue source for the company.

8. A method of using a Zero Cost Loyalty & Consumer Engagement Program as claimed in claim 1 wherein the said profiling of consumers is used to effectively position and market the company's services or products.

9. A method of using a Zero Cost Loyalty & Consumer Engagement Program as claimed in claim 6 wherein the said profiling of consumers can be an alternate revenue source for the company.

10. A method of using a Zero Cost Loyalty & Consumer Engagement Program as claimed in claim 6 wherein the said profiling of consumers is used to effectively position and market the company's services or products.
